(19) United States
(12) Patent Application Publication
(10) Pub. No.: US 2026/0302024 A1
(43) Pub. Date: Oct. 1, 2026

(54) LAMINATED COIL

(71) Applicants: TAMURA CORPORATION, Toyko (JP); TOHOKU UNIVERSITY, Miyagi (JP)

(72) Inventors: Tatsuya KIYOTA, Tokyo (JP); Yusuke TANAHASHI, Saitama (JP); Hiro EINISHI, Saitama (JP); Ryoya OKUMURA, Saitama (JP); Yoshikazu TAKAHASHI, Miyagi (JP); Naoki TAKAGI, Miyagi (JP)

(73) Assignees: TAMURA CORPORATION, Toyko (JP); TOHOKU UNIVERSITY, Miyagi (JP)

(21) Appl. No.: 19/570,564

(22) Filed: Mar. 18, 2026

(30) Foreign Application Priority Data
Mar. 31, 2025 (JP) 2025-058224

(51) Int. Cl. H01F 5/04

(52) U.S. Cl. CPC H01F 5/04

(57) ABSTRACT

The laminated coil 10 is a laminated coil 10 formed by stacking a plurality of coupled cells 4a to 4f, and the cells 4a to 4f have a through hole 43 formed at a center, a resin layer 44 made of an insulating member, a surface-layer coil pattern 45 formed on a front surface of the resin layer 44 and made of a conductive member, a back-layer coil pattern 46 formed on a back surface of the resin layer 44 and made of a conductive member, a through via 47 that electrically connects the surface-layer coil pattern 45 and the back-layer coil pattern 46, and a connecting portion 48 that couples adjacent cells 4a to 4f and is bent to stack the cells 4a to 4f. The current path of current flowing through the cell 4b to 4e has a total number of turns of 1.0 turns or less.

### CROSS-REFERENCE TO RELATED APPLICATION

This application is based upon and claims the benefit of priority from Japanese Patent Application No. 2025-058224, filed on Mar. 31, 2025, the entire contents of which are incorporated herein by reference.

### FIELD OF INVENTION

The present disclosure relates to a laminated coil.

### BACKGROUND

A laminated coil is known in which cells each having a coil pattern composed of an insulating member such as ceramic and a conductive member are alternately stacked. A plurality of cells are provided, and the plurality of cells are coupled by a connecting portion. By bending this connecting portion, the cells are stacked.

### PROBLEMS TO BE SOLVED BY INVENTION

As in Patent Document 1, when the connecting portion is only bent in the same direction, only 0.5 turns to 0.75 turns can be wound per layer. Therefore, the number of turns of the laminated coil cannot be ensured.

The present disclosure is achieved to address the above-described problem, and an object thereof is to provide a laminated coil that can ensure a number of turns of 1.0 turns or more.

### SUMMARY OF INVENTION

A laminated coil of the present disclosure is a laminated coil formed by stacking a plurality of coupled cells, in which the cells include: a through hole formed at a center; a resin layer made of an insulating member; a surface-layer coil pattern formed on a front surface of the resin layer and made of a conductive member; a back-layer coil pattern formed on a back surface of the resin layer and made of a conductive member; a through via that electrically connects the surface-layer coil pattern and the back-layer coil pattern; and a connecting portion that couples adjacent cells and is bent to stack the cells, in which a current path of current flowing through the cells has a total number of turns of 1.0 turns or more, the total number of turns being a sum of the surface-layer coil pattern and the back-layer coil pattern.

According to the present disclosure, it is possible to obtain a laminated coil that can ensure a number of turns of 1.0 turns or more.

### BRIEF DESCRIPTION OF DRAWINGS

FIG. 1 is a schematic diagram of a laminated coil of an embodiment.

FIG. 2 is a schematic diagram of a primary coil showing a state before the respective cells of the embodiment are stacked.

FIG. 3 is a plan view of a cell.

FIG. 4 is an A-A sectional view of FIG. 3.

FIG. 5 is a schematic diagram of a secondary coil showing a state before the respective cells are stacked.

FIG. 6 is a schematic plan view of the primary coil showing a state after the respective cells are stacked.

FIG. 7 is a schematic diagram showing a path of current flowing through the respective cells of the primary coil.

FIG. 8 is a diagram showing a path of current flowing through a surface-layer coil pattern of the respective cells.

FIG. 9 is a diagram showing a path of current flowing through a back-layer coil pattern of the respective cells.

FIGS. 10A and 10B are diagrams showing a current path for calculating the number of turns as 0.125.

FIGS. 11A-11C are diagrams showing a current path for calculating the number of turns as 0.25.

FIGS. 12A-12C are diagrams showing a current path for calculating the number of turns as 0.50.

FIG. 13 is a schematic diagram of a primary coil showing a state before the respective cells of another embodiment are stacked.

FIG. 14 is a schematic diagram of a primary coil showing a state before the respective cells of another embodiment are stacked.

FIG. 15 is a schematic diagram of a primary coil showing a state before the respective cells of another embodiment are stacked.

FIG. 16 is a schematic diagram of a secondary coil showing a state before the respective cells of the embodiment are stacked.

FIG. 17 is a schematic diagram of a secondary coil showing a state before the respective cells of the embodiment are stacked.

### DETAILED DESCRIPTION OF THE EMBODIMENTS

### EMBODIMENT

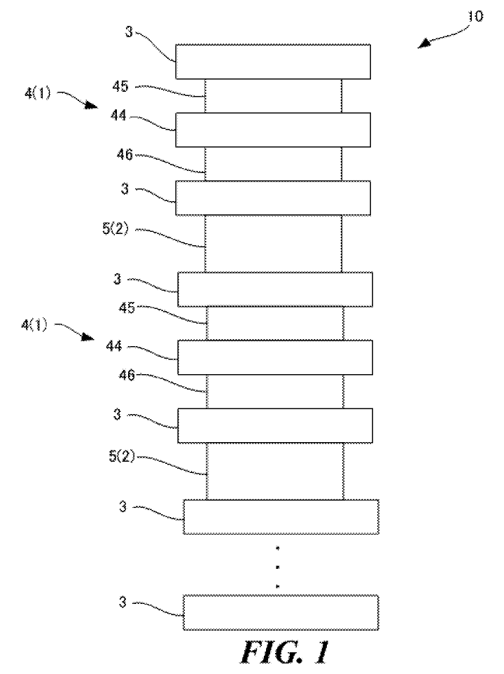

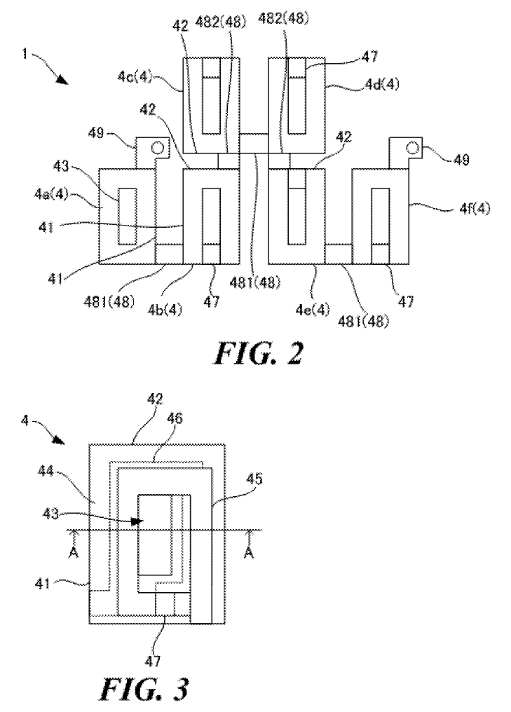

A laminated coil according to an embodiment will be described with reference to the figures. FIG. 1 is a schematic diagram of the laminated coil 10 of the present embodiment. The laminated coil 10 includes a primary coil 1, a secondary coil 2, and an insulating layer 3. The primary coil 1 and the secondary coil b each have a plurality of cells 4 and 5 that form one layer (see FIGS. 2 and 5), and the cells 4 of the primary coil 1 and the cells 5 of the secondary coil 2 are alternately stacked. The insulating layer 3 is provided between the respective layers of the cells of the primary coil 1 and the cells 5 of the secondary coil 2.

FIG. 2 is a schematic diagram of the primary coil 1 showing a state before the respective cells 4 are stacked. The primary coil 1 has a plurality of cells 4, as shown in FIG. 2. In the present embodiment, the primary coil 1 has six cells 4a to 4f, but the number of the cells 4 is not limited thereto. The plurality of cells 4 are stacked such that adjacent cells 4 face each other by being bent at a connecting portion 48 described later. Thus, by bending the connecting portion 48, the plurality of cells 4 are stacked, thereby forming the primary coil 1. Note that, when the cells 4a to 4f are not distinguished, they are simply referred to as cells 4. Further, in the present embodiment, in a state after the cells 4 are stacked by bending the connecting portion 48, the cell 4 positioned at the uppermost layer is the cell 4f, and the cell 4 positioned at the lowermost layer is the cell 4a.

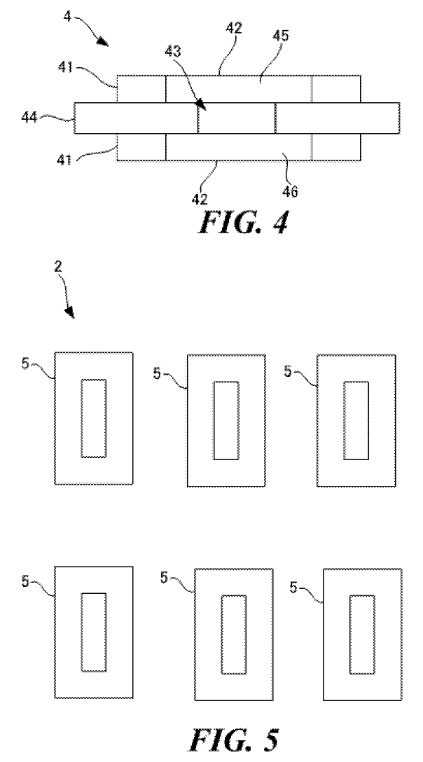

FIG. 3 is a plan view of a cell 4. FIG. 4 is an A-A sectional view of FIG. 3. The cell 4 has a rectangular shape. That is, the cell 4 has a pair of long side portions 41 and a pair of short side portions 42. Each long side portion 41 is longer than each short side portion 42. Further, as shown in FIGS. 2, 3, and 4, the cell 4 has a through hole 43, a resin layer 44, a surface-layer coil pattern 45, a back-layer coil pattern 46, a through via 47, a connecting portion 48, and a terminal portion 49. Note that, in FIG. 3, for convenience of explanation, the back-layer coil pattern 46 is illustrated as being shifted from the surface-layer coil pattern 45, but in actuality, the back-layer coil pattern 46 overlaps the surface-layer coil pattern 45.

The through hole 43 is a hole formed at the center of the cell 4. A core (not shown) is inserted into the through hole 43. The through holes 43 of the respective cells 4 overlap each other in a state in which the respective cells 4 are stacked.

Note that a dust core, a ferrite core, a laminated steel plate, a metal composite core, or the like can be used for the core 1. The metal composite core is a magnetic body formed by kneading magnetic powder and resin, and curing the resin. The core has, for example, a θ shape composed of three leg portions and a pair of yoke portions connecting the three leg portions. This θ-shaped core can be formed by combining two E-shaped core members, or by combining an E-shaped core member and an I-shaped core member. Then, among the three leg portions, a center leg disposed at the center is inserted into the through hole 43. Note that the shape of the core is not limited to the θ shape composed of three leg portions, and may be an annular shape composed of two leg portions. For example, the core may be formed by joining two U-shaped core members. In this case, two laminated coils 10 may be prepared, and the laminated coils 10 each having the through hole 43 may be mounted on the respective two leg portions.

The resin layer 44 is formed of an insulating member. Examples of the insulating member include polyimide. However, the insulating member is not limited to polyimide, and may be any member that can insulate the surface-layer coil pattern 45 and the back-layer coil pattern 46 and can be subjected to bending. For example, ceramic may be used for a portion excluding the connecting portion 48. In this case, polyimide is used for the connecting portion 48. The resin layer 44 is provided between the surface-layer coil pattern 45 and the back-layer coil pattern 46. The resin layer 44 insulates the surface-layer coil pattern 45 and the back-layer coil pattern 46 from each other. The through hole 43 is formed at the center of the resin layer 44, and the resin layer 44 has an annular shape. That is, the resin layer 44 has an annular surface.

The surface-layer coil pattern 45 and the back-layer coil pattern 46 are formed of a conductive member. For example, copper and aluminum can be mentioned as the conductive member constituting the surface-layer coil pattern 45 and the back-layer coil pattern 46. In the present embodiment, the surface-layer coil pattern 45 and the back-layer coil pattern 46 are formed of copper.

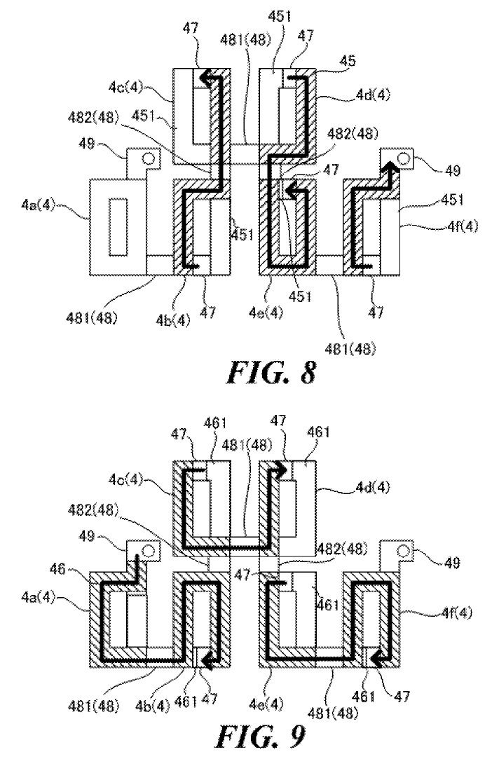

The surface-layer coil pattern 45 is provided on the front surface of the resin layer 44. The front surface of the resin layer 44 is one surface of the annular surface of the resin layer 44, and the other surface of the annular surface is referred to as a back surface. The surface-layer coil pattern 45 has an annular shape so as to surround the through hole 43. However, the surface-layer coil pattern 45 is provided with an unconnected portion 451 in which the surface-layer coil pattern 45 is not connected (see FIG. 8). The unconnected portion 451 is a portion where the resin layer 44 is exposed and does not become a path through which current flows.

The back-layer coil pattern 46 is provided on the back surface of the resin layer 44. The back-layer coil pattern 46 has an annular shape, and is arranged so as to overlap the surface-layer coil pattern 45 via the resin layer 44. However, the back-layer coil pattern 46 is provided with an unconnected portion 461 in which the back-layer coil pattern 46 is not connected (see FIG. 9). The unconnected portion 461 is a portion where the resin layer 44 is exposed and does not become a path through which current flows.

The surface-layer coil pattern 45 and the back-layer coil pattern 46 constitute paths through which current flows. Although details will be described later, in each cell 4, the total number of turns through which current flows in the surface-layer coil pattern 45 and the back-layer coil pattern 46 is 1.0 turn or more. In addition, in each cell 4, the total number of turns through which current flows in the surface-layer coil pattern 45 and the back-layer coil pattern 46 is preferably 1.75 turns or less. By setting the number of turns to 1.75 turns or less, the thicknesses of the surface-layer coil pattern 45 and the back-layer coil pattern 46 do not increase, and an increase in the size of the multilayer coil 10 can be prevented.

The through via 47 electrically connects the surface-layer coil pattern 45 and the back-layer coil pattern 46. The through via 47 is a hole that penetrates from the front surface to the back surface of the annular surface of the resin layer 44. A conductive member such as copper plating is applied to an inner surface of the hole of the through via 47. Therefore, the through via 47 can cause current that has flowed to the surface-layer coil pattern 45 to flow to the back-layer coil pattern 46, or can cause current that has flowed to the back-layer coil pattern 46 to flow to the surface-layer coil pattern 45.

The through via 47 is provided at a central portion of the short side portion 42 of each cell 4. By providing the through via 47 in the short side portion 42, when a core is inserted into the through hole 43 and the laminated coil 10 becomes a component member of a reactor or a transformer, the through via 47 can be arranged at a position that does not overlap a yoke portion of the core. The number of the through vias 47 is smaller than the number of the cells 4 by one. Therefore, in the present embodiment, the through via 47 is not provided in the cell 4a which is the lowermost layer. In other words, one through via 47 is provided in each of the cells 4b to 4f.

The connecting portion 48 couples adjacent cells 4. In the connecting portion 48, the resin layer 44, the surface-layer coil pattern 45, and the back-layer coil pattern 46 are formed. That is, also in the connecting portion 48, the surface-layer coil pattern 45 or the back-layer coil pattern 46 can serve as a path through which current flows. Therefore, by the connecting portion 48, adjacent cells 4 can be electrically connected. In this manner, current can be caused to flow from the cell 4a at the lowermost layer to the cell 4f at the uppermost layer via the surface-layer coil pattern 45, the back-layer coil pattern 46, the through via 47, and the connecting portion 48.

The connecting portion 48 is formed at one end portion or both end portions of either the surface-layer coil pattern 45 or the back-layer coil pattern 46 that each cell 4 has. That is, one or two connecting portions 48 are provided in each cell 4. More specifically, when the respective cells 4 are stacked, one connecting portion 48 is provided in each cell 4 that becomes the uppermost layer and the lowermost layer, and two connecting portions 48 are provided in each cell 4 stacked between the uppermost layer and the lowermost layer. That is, in the present embodiment, one connecting portion 48 is provided in each of the cells 4a and 4f, and two connecting portions 48 are provided in each of the cells 4b to 4e. By sequentially bending the respective connecting portions 48, the respective cells 4 are stacked to form the primary coil 1.

The connecting portion 48 has a horizontal bent portion 481 and a vertical bent portion 482. The horizontal bent portion 481 is provided in the long side portion 41 of the cell 4, and connects the long side portions 41 of adjacent cells 4. The horizontal bent portion 481 is bent along an extending direction of the long side portion 41 of the cell 4. The vertical bent portion 482 is provided in the short side portion 42 of the cell 4, and connects the short side portions 42 of adjacent cells 4. The vertical bent portion 482 is bent along an extending direction of the short side portion 42 of the cell 4.

The terminal portions 49 are connected to a terminal of an external device (not shown). The terminal portions 49 are provided in the cells 4 positioned at the uppermost layer and the lowermost layer. That is, the terminal portions 49 are provided in the cell 4a and the cell 4f. More specifically, the terminal portions 49 are provided in the short side portion 42 of each of the cell 4a and the cell 4f.

The terminal portion 49 is electrically connected to the surface-layer coil pattern 45 or the back-layer coil pattern 46, and current supplied from the external device flows to the surface-layer coil pattern 45 or the back-layer coil pattern 46 via the terminal portion 49. In the present embodiment, the terminal portion 49 provided in the cell 4a is connected to the back-layer coil pattern 46 of the cell 4a. The terminal portion 49 provided in the cell 4f is connected to the surface-layer coil pattern 45 of the cell 4f.

In this manner, one cell 4 is provided with two connecting portions 48, or one connecting portion 48 and one terminal portion 49. The two connecting portions 48, or the one connecting portion 48 and the one terminal portion 49 are not provided on the same side in one cell 4. That is, in the cells 4b to 4e having two connecting portions 48, one connecting portion 48 is provided in the long side portion 41 and the other connecting portion 48 is provided in the short side portion 42. Similarly, in the cells 4a and 4f having one connecting portion 48 and one terminal portion 49, the connecting portion 48 is provided in the long side portion 41 and the terminal portion 49 is provided in the short side portion 42.

FIG. 5 is a schematic diagram of a secondary coil 2 showing a state before the respective cells 5 are stacked. The secondary coil 2 has a plurality of cells 5, as shown in FIG. 5. In the present embodiment, the plurality of cells 5 are not coupled. The cells 5 of the secondary coil 2 have through holes having the same size as the through hole of the cell 4, and are stacked on the cells 4 of the primary coil 1 such that the through holes 43 of the cells 4 overlap the through holes. The cells 5 of the secondary coil 2 are arranged between the cells 4 of the primary coil 1. Also in the cells 5 of the secondary coil 2, although not shown, similarly to the cells 4 of the primary coil 1, a resin layer is formed, and a surface-layer coil pattern and a back-layer coil pattern are formed on the annular surface of the resin layer.

As shown in FIG. 1, the insulating layer 3 is provided between the cells 4 of the primary coil 1 and the cells 5 of the secondary coil 2. The insulating layer 3 insulates the cells 4 of the primary coil 1 and the cells 5 of the secondary coil 2. The insulating layer 3 is formed of an insulating member. As the insulating member, the same type as the resin layer 44 of the primary coil 1 can be used.

Further, the insulating layer 3 is provided so as to cover entire surfaces of the cells 4 of the primary coil 1 and the cells 5 of the secondary coil 2. The insulating layer 3 insulates the cells 4 and the cells 5. The insulating layer 3 is an annular shape with a hole having the same size as the through hole 43. The hole of the insulating layer 3 overlaps the through hole 43 of the cell 4 and the through hole of the cell 5. The insulating layer 3 may be larger than the cell 4 and the cell 5, but may be at least the same size.

The insulating layer 3 is also provided between the through vias 47 of the respective cells 4. In the present embodiment, in a state in which the respective cells 4 are stacked, a part of the through vias 47 is arranged on the same plane (on an extension region orthogonal to the annular surface of the cell 4). Therefore, the insulating layer 3 insulates between the through vias 47.

Next, a method for manufacturing the laminated coil 10 will be described. First, an insulating member constituting the insulating layer 3 is joined to the cell 4a of the primary coil 1 with an adhesive or the like. Then, the cell 5 of the secondary coil 2 is joined onto the insulating layer 3 with an adhesive or the like. The insulating member constituting the insulating layer 3 is joined to the cell 5 of the secondary coil 2, and thereafter, the horizontal bent portion 481 that couples the cells 4a and 4b is bent along the extending direction of the long side portion 41. Hereinafter, bending the horizontal bent portion 481 along the extending direction of the long side portion 41 is referred to as horizontal bending. The cell 4b is placed on the insulating layer 3 and is stacked on an extension line of the cell 4a such that the through holes 43 of the cells 4a and 4b overlap each other.

After the horizontal bending is completed and the cell 4b is stacked on the cell 4a, the process shifts to bending of the cell 4c. Similarly to bending of the cell 4b, the insulating layer 3 and the cell 5 of the secondary coil 2 are joined onto the cell 4b of the primary coil 1. Then, the vertical bent portion 482 that couples the cell 4b and the cell 4c is bent along the extending direction of the short side portion 42. Hereinafter, bending the vertical bent portion 482 along the extending direction of the short side portion 42 is referred to as vertical bending. The cell 4c is placed on the insulating layer 3 and is stacked on the extension line of the cells 4a and 4b.

After the vertical bending is completed and the cell 4c is stacked on the cell 4a and 4b, the process shifts to bending of the cell 4d. Similarly to the cell 4b, the cell 4d is joined with the insulating layer 3 and the cell 5 of the secondary coil 2, and thereafter, by horizontal bending, the cell 4d is placed on the insulating layer 3 and is stacked on the extension line of the cells 4a to 4c. Then, when stacking of the cell 4d is completed, the process shifts to bending of the cell 4e, and similarly to the above, first the insulating layer 3 and the cell 5 of the secondary coil 2 are joined, and the cell 4e is placed on the insulating layer 3 by vertical bending and is stacked on the extension line of the cells 4a to 4d. Lastly, similarly to the above for the cell 4f, first the insulating layer 3 and the cell 5 of the secondary coil 2 are joined, the horizontal bent portion 481 coupling the cell 4e and the cell 4f is horizontally bent, and the cell 4f is stacked on the cells 4a to 4e. In this manner, in the cells 4 of the primary coil 1, the respective cells 4 are stacked and the laminated coil 10 is manufactured by alternately repeating horizontal bending and vertical bending.

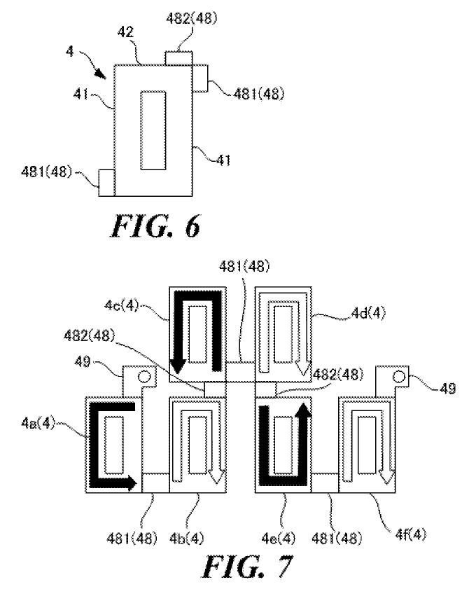

FIG. 6 is a schematic plan view of the primary coil 1 showing a state after the respective cells are stacked. As shown in FIG. 6, the connecting portions 48 of the primary coil in which the respective cells 4 are stacked are formed at three locations on the respective long side portions 41 and the short side portion 42. The horizontal bent portion 481 coupling the cell 4a and the cell 4b and the horizontal bent portion 481 coupling the cell 4e and the cell 4f are formed on one long side portion 41, and these two horizontal bent portions 481 are arranged on the same plane (on the extension region orthogonal to the annular surface of the cell 4). The horizontal bent portion 481 coupling the cell 4c and the cell 4d is formed on the other long side portion 41. Further, the vertical bent portion 482 coupling the cell 4b and the cell 4c and the vertical bent portion 482 coupling the cell 4d and the cell 4e are formed on one short side portion 42, and these two vertical bent portions 482 are arranged on the same plane (on the extension region orthogonal to the annular surface of the cell 4).

A current path of such a laminated coil 10 will be described. FIG. 7 is a schematic diagram showing a path of current flowing through the respective cells 4 of the primary coil 1. As shown in FIG. 7, the current flows through the respective cells 4 counterclockwise (solid black arrows in FIG. 7) or clockwise (hollow arrows in FIG. 7). The current alternately repeats counterclockwise and clockwise through the respective cells 4.

Details of a path through which current flows are shown in FIGS. 8 and 9. FIG. 8 is a diagram showing a path of current flowing through the surface-layer coil pattern 45 of each of the cells 4a to 4f.FIG. 9 is a diagram showing a path of current flowing through the back-layer coil pattern 46 of each of the cells 4a to 4f.

Current is supplied from the terminal portion 49 provided in the cell 4a. Since this terminal portion 49 is connected to the back-layer coil pattern 46, the current supplied from the terminal portion 49 flows through the back-layer coil pattern 46 of the cell 4a and heads toward the horizontal bent portion 481, as shown in FIG. 9. The current that has reached the horizontal bent portion 481 flows to the back-layer coil pattern 46 of the cell 4b via the horizontal bent portion 481, and flows to the through via 47 so as to make one round of the back-layer coil pattern 46 of the cell 4b through the long side portion 41, the short side portion 42, and the long side portion 41. Then, the current flows from the back-layer coil pattern 46 of the cell 4b to the surface-layer coil pattern 45 via the through via 47. The current that has flowed to the surface-layer coil pattern 45 flows toward the vertical bent portion 482 connected to a short side portion opposite to the short side portion 42 in which the through via 47 is provided, as shown in FIG. 8. Then, by the vertical bent portion 482, the current flows from the surface-layer coil pattern 45 of the cell 4b to the surface-layer coil pattern 45 of the cell 4c.

The current flowing through the surface-layer coil pattern 45 of the cell 4c heads toward the through via 47. Then, after flowing through the long side portion 41, the current flows from the surface-layer coil pattern 45 of the cell 4c to the back-layer coil pattern 46 via the through via 47. The current that has flowed to the back-layer coil pattern 46 of the cell 4c flows toward the horizontal bent portion 481 provided in the long side portion 41, as shown in FIG. 9. Then, the current flows from the back-layer coil pattern 46 of the cell 4c to the back-layer coil pattern 46 of the cell 4d via the horizontal bent portion 481. The current that has flowed to the back-layer coil pattern 46 of the cell 4d flows toward the through via 47.

The current flows from the back-layer coil pattern 46 of the cell 4d to the surface-layer coil pattern 45 via the through via 47. The current that has flowed to the surface-layer coil pattern 45 heads toward the vertical bent portion 482 provided in the short side portion 42, as shown in FIG. 8, and flows from the surface-layer coil pattern 45 of the cell 4d to the surface-layer coil pattern 45 of the cell 4e via the vertical bent portion 482. The current that has flowed to the surface-layer coil pattern 45 of the cell 4e flows toward the through via 47 so as to make one round of the cell 4e. Then, the current flows from the surface-layer coil pattern 45 of the cell 4e to the back-layer coil pattern 46 via the through via 47.

The current that has flowed to the back-layer coil pattern 46 of the cell 4e heads toward the horizontal bent portion 481 provided in the long side portion 41, as shown in FIG. 9, and flows from the back-layer coil pattern 46 of the cell 4e to the back-layer coil pattern 46 of the cell 4f via the horizontal bent portion 481. The current flowing through the back-layer coil pattern 46 of the cell 4f heads toward the through via 47 so as to make one round of the cell 4f. Then, the current flows from the back-layer coil pattern 46 of the cell 4f to the surface-layer coil pattern 45 via the through via 47. The current that has flowed to the surface-layer coil pattern 45 of the cell 4f flows toward the terminal portion 49 provided in the cell 4f, as shown in FIG. 8.

The current follows the path as described above. Then, at least in the current path of current flowing through each of the cells 4b to 4e sandwiched between the uppermost layer and the lowermost layer, a total of the path of the surface-layer coil pattern 45 and the path of the back-layer coil pattern 46 is one turn or more.

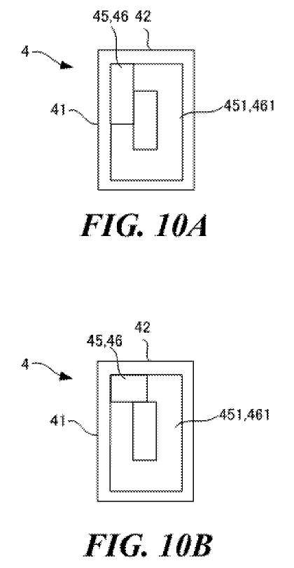

Here, the definition of a turn will be described with reference to the drawings. FIGS. 10A-10B are diagrams showing a current path for calculating the number of turns as 0.125. As shown in FIGS. 10A and 10B, when the current path has a length of one-half or less of the long side portion 41 or the short side portion 42 of the surface-layer coil pattern 45 or the back-layer coil pattern 46, the number of turns is calculated as 0.125.

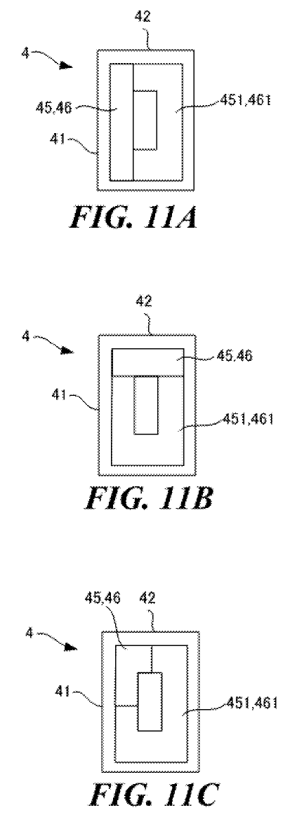

FIGS. 11A-11C are diagrams showing a current path for calculating the number of turns as 0.25. As shown in FIGS. 11A and 11B, when the current path has a length of one side of the long side portion 41 or the short side portion 42 of the surface-layer coil pattern 45 or the back-layer coil pattern 46 (more specifically, a length that is longer than one-half of the long side portion 41 or the short side portion 42 and up to one side), the number of turns is calculated as 0.25 Also, as shown in FIG. 11C, when the current path extends over two sides, namely the long side portion 41 and the short side portion 42, and the current path of the long side portion 41 and the short side portion 42 has a length of one-half or less of the long side portion 41 or the short side portion 42 of the surface-layer coil pattern 45 or the back-layer coil pattern 46, the number of turns is calculated as 0.25.

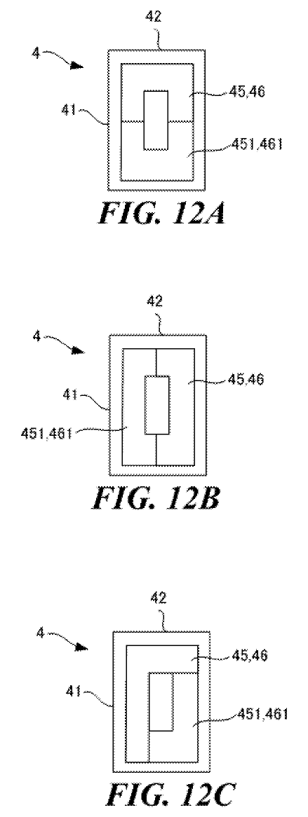

FIGS. 12A-12C are diagrams showing a current path for calculating the number of turns as 0.50. As shown in FIG. 12A, when the current path includes one side of the short side portion 42 and one-half or less of the long side portions 41 extending from both end portions of the one side, the number of turns is calculated as 0.50. Also, as shown in FIG. 12B, when the current path includes one side of the long side portion 41 and one-half or less of the short side portions 42 extending from both ends of the one side, the number of turns is calculated as 0.50. Further, as shown in FIG. 12C, when the current path includes one side of the long side portion 41 (a length longer than one-half of the long side portion 41 and up to one side length of the long side portion 41) and one side of the short side portion 42 (a length longer than one-half of the short side portion 42 and up to one side length of the short side portion 42), the number of turns is calculated as 0.50.

Based on the above rules for calculating the number of turns, the total number of turns of the surface-layer coil pattern 45 and the back-layer coil pattern 46 of each of the cells 4b to 4e of the present embodiment is calculated based on the current paths of FIGS. 8 and 9. In the cell 4b of the present embodiment, in the surface-layer coil pattern 45, since a current path from the through via 47 toward the long side portion 41 has a length of one-half or less of the short side portion 42, as shown in FIG. 10B, the number of turns is “0.125”. Further, as shown in FIG. 12C, the number of turns of a current path flowing through one side of the long side portion 41 and one side of the short side portion 42 is “0.50”. Therefore, the total number of turns of the surface-layer coil pattern 45 of the cell 4b is “0.625”.

On the other hand, in the back-layer coil pattern 46 of the cell 4b, a current path including one side of the long side portion 41 connected to the horizontal bent portion 481 coupling the cell 4a and the cell 4b and one side of the short side portion 42 has a number of turns of “0.50”, as shown in FIG. 12C. Further, one side of the long side portion 41 extending from an end portion of the short side portion 42 constitutes the current path, and as shown in FIG. 11A, the number of turns is “0.25”. Then, the current path from an end portion of the long side portion 41 toward the through via 47 has a number of turns of “0.125”, as shown in FIG. 10B. Therefore, the total number of turns of the back-layer coil pattern 46 of the cell 4b is “0.875”. Therefore, the total number of turns of the surface-layer coil pattern 45 and the back-layer coil pattern 46 of the cell 4b is “1.5”.

Next, when calculating the number of turns of the cell 4c, in the current path flowing through the surface-layer coil pattern 45, a portion from the vertical bent portion 482 coupled to the cell 4b to one side of the long side portion 41 has a number of turns of “0.25”, and the current path from an end portion of the long side portion 41 toward the through via 47 has a number of turns of “0.125”. Therefore, the total number of turns of the surface-layer coil pattern 45 of the cell 4c is “0.375”. On the other hand, in the back-layer coil pattern 46, the current path from the through via 47 to an end portion of the short side portion 42 has a number of turns of “0.125”, and the current path in one side of the long side portion 41 and one side of the short side portion extending from an end portion of the long side portion 41 toward the horizontal bent portion 481 has a number of turns of “0.50”. Therefore, the total number of turns of the back-layer coil pattern 46 of the cell 4c is “0.625”. Therefore, the total number of turns of the surface-layer coil pattern 45 and the back-layer coil pattern 46 of the cell 4c is “1.0”.

In the current path of the surface-layer coil pattern 45 of the cell 4d, similarly to the surface-layer coil pattern 45 of the cell 4b and the back-layer coil pattern 46 of the cell 4c, the numbers of turns are “0.125” and “0.5”, and the total number of turns is “0.625”. On the other hand, the current path of the back-layer coil pattern 46, similarly to the surface-layer coil pattern 45 of the cell 4c, has numbers of turns of “0.25” and “0.125”, and the total number of turns is “0.375”. Therefore, the total number of turns of the surface-layer coil pattern 45 and the back-layer coil pattern 46 of the cell 4d is “1.0”.

In the current path of the surface-layer coil pattern 45 of the cell 4e, similarly to the number of turns of the back-layer coil pattern 46 of the cell 4b, the numbers of turns are “0.5”, “0.25”, and “0.125”, and the total is “0.875”. On the other hand, the current path of the back-layer coil pattern 46, similarly to the back-layer coil pattern 46 of the cell 4c, has numbers of turns of “0.125” and “0.50”, and the total is “0.625”. Therefore, the total number of turns of the surface-layer coil pattern 45 and the back-layer coil pattern 46 of the cell 4e is “1.5”.

In this manner, in each of the cells 4b to 4e sandwiched between the uppermost layer and the lowermost layer, the total number of turns of the current paths in the surface-layer coil pattern 45 and the back-layer coil pattern 46 is “1.0” or more.

In the present embodiment, the total number of turns of the surface-layer coil pattern 45 and the back-layer coil pattern 46 of the cell 4f is 1.0 or more. The current path of the surface-layer coil pattern 45 of the cell 4f is the same as that of the surface-layer coil pattern 45 of the cell 4b, and the number of turns is “0.625”, and the current path of the back-layer coil pattern 46 is the same as that of the back-layer coil pattern 46 of the cell 4b, and the number of turns is “0.875”. Therefore, the total number of turns of the surface-layer coil pattern 45 and the back-layer coil pattern 46 of the cell 4f is “1.5”.

### EFFECT

As described above, the laminated coil 10 of the present embodiment is a laminated coil 10 in which a plurality of coupled cells 4a to 4f are stacked, and the cells 4a to 4f have a through hole 43 formed at the center, a resin layer 44 made of an insulating member, a surface-layer coil pattern 45 formed on a front surface of the resin layer 44 and made of a conductive member, a back-layer coil pattern 46 formed on a back surface of the resin layer 44 and made of a conductive member, and a through via 47 that electrically connects the surface-layer coil pattern 45 and the back-layer coil pattern 46, and in a current path of current flowing through the cells 4b to 4e, a total number of turns of the surface-layer coil pattern 45 and the back-layer coil pattern 46 is 1.0 turns or more.

In this manner, the surface-layer coil pattern 45 and the back-layer coil pattern 46 are provided on the front surface and the back surface of the resin layer 44, and the total number of turns of both of them serving as current paths is set to 1.0 or more. Therefore, the number of turns of the laminated coil 10 can be ensured.

The current path of current flowing through the cell 4 has a total number of turns of 1.75 turns or less, the total number of turns being the sum of the surface-layer coil pattern 45 and the back-layer coil pattern 46.

For example, if a coil pattern is formed such that a current path of two turns or more is formed in one layer, a thickness of the one layer becomes thick. Therefore, the laminated coil becomes large-sized. Thus, as in the present embodiment, by setting the number of turns to 1.75 or less, the number of turns can be ensured without increasing the size of the laminated coil 10.

The cells 4a to 4f further include connecting portions 48 that couple adjacent cells 4a to 4f and are bent to stack the adjacent cells 4a to 4f, and the cells 4a to 4f have a rectangular shape, and, in one cell 4a to 4f, the connecting portion 48 is not provided on the same side. Accordingly, the respective cells 4a to 4f can be stacked without interfering with each other.

Further, a part of the through vias 47 is arranged on the same plane. In the conventional art, in order to provide insulation between the through vias 47 provided in the respective cells 4, the through vias 47 are arranged in the respective cells 4 so as not to be stacked on the same plane, which has caused an increase in the size of the laminated coil 10. However, as in the present embodiment, by interposing the insulating layer 3 between the through vias 47, the through vias 47 can be provided on the same plane. Therefore, the laminated coil 10 can be reduced in size.

### OTHER EMBODIMENT

In the description herein, although embodiments according to the present disclosure are described, said embodiments are only provided as examples and are not intended to limit the scope of claims. The above-described embodiments may be implemented by other various forms, and various omissions, replacements, and changes may be made without departing from the scope of claims. The embodiments and modifications thereof are included in the invention described in the claims and equivalent ranges thereto, as well as in the scope and abstract of the invention.

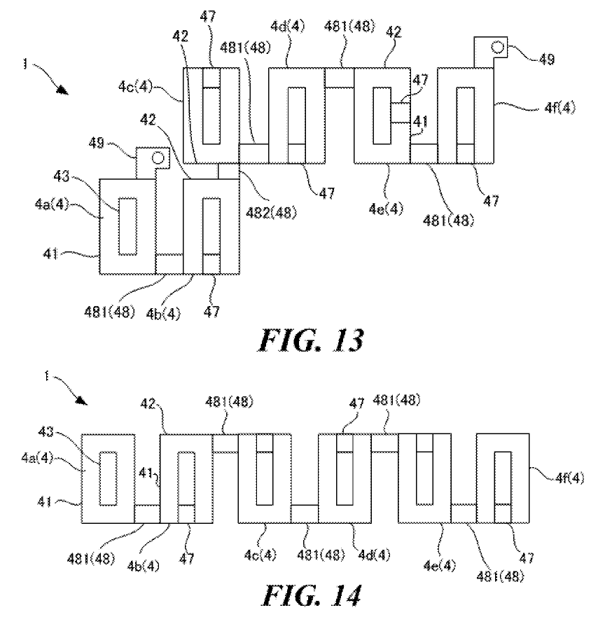

In the above embodiment, the through via 47 is provided at a central portion of the short side portion 42, but the present embodiment is not limited thereto. FIG. 13 is a schematic diagram of a primary coil showing a state before the respective cells of another embodiment are stacked. As shown in FIG. 13, for example, the through via 47 may be provided in the long side portion 41 of the cell 4e.

Further, in the above embodiment, when stacking the respective cells 4 of the primary coil 1, horizontal bending and vertical bending are alternately repeated, but the present embodiment is not limited thereto. For example, as shown in FIG. 13, the cell 4d and the cell 4e may be connected by the horizontal bent portion 481 instead of the vertical bent portion 482. That is, the cells 4d to 4f may be stacked by continuously performing horizontal bending. In such a configuration, the numbers of turns of the surface-layer coil pattern 45 and the back-layer coil pattern 46 of the cell 4f are both “0.875”, and the total number of turns is “1.75”.

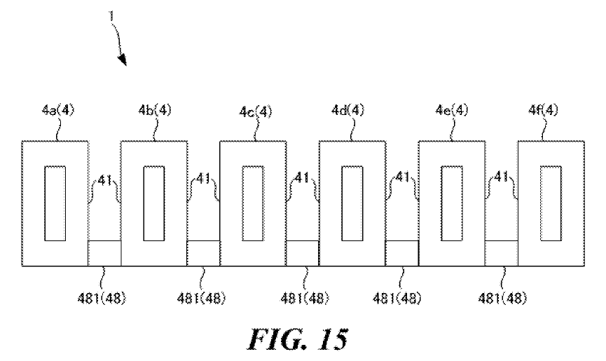

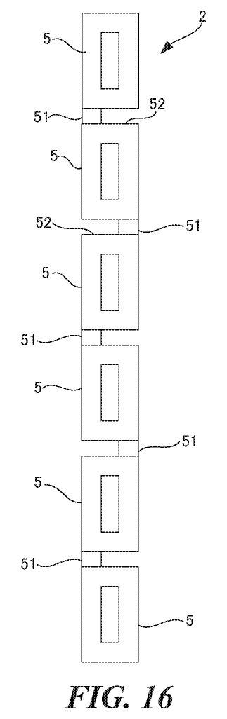

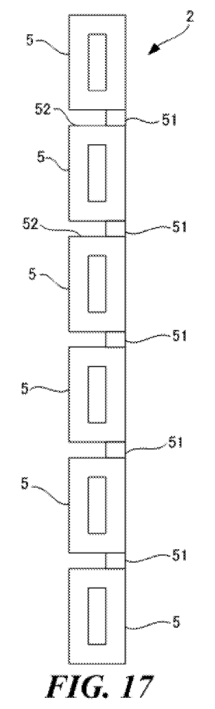

Further, as shown in FIGS. 14 and 15, the primary coil 1 may be configured such that the cells 4a to 4f are arranged in a straight line and the long side portions 41 of the cells 4a to 4f are coupled only by the horizontal bent portions 481. That is, the primary coil 1 may be stacked only by horizontal bending. In this case, the secondary coil 2 is provided with connecting portions 51 that couple the respective cells 5, as shown in FIGS. 16 and 17. Then, the respective cells 5 are arranged in a straight line, and the connecting portions 51 connect the short side portions 52 of the respective cells 5. That is, bending all of the connecting portions 51 along the short side portions 52 is vertical bending. In this manner, even if the primary coil 1 is configured to be only horizontally bent and the secondary coil 2 is configured to be only vertically bent, the cells 4 of the primary coil 1 and the cells 5 of the secondary coil 2 can be stacked without interfering with each other. Note that the coupling of the primary coil 1 and the secondary coil 2 may be reversed, and the primary coil may be configured to be only vertically bent and the secondary coil 2 may be configured to be only horizontally bent.

The connecting portions 48 of the primary coil 1 may be configured so that the primary coil 1 is subjected only to horizontal bending as shown in FIGS. 14 and 15, and the secondary coil 2 may be configured without coupling as in the embodiment; alternatively, the connecting portions 48 of the primary coil 1 may be configured so that the primary coil 1 is subjected only to vertical bending as shown in FIGS. 16 and 17, and the secondary coil 2 may be configured without coupling. Even in such a case, the cells 4 of the primary coil 1 and the cells 5 of the secondary coil 2 can be stacked without interfering with each other.

Further, in the above embodiment, the primary coil 1 is stacked by alternately performing horizontal bending and vertical bending to stack the respective cells 4; however, the secondary coil 2 may be stacked by alternately performing horizontal bending and vertical bending. In this case, the cells 4 of the primary coil 1 may be not coupled, or the cells 4 may be arranged in a straight line and the connecting portions 48 (horizontal bent portions 481) may be provided only in the long side portions 41 of the respective cells 4, and the respective cells 4 may be stacked only by horizontal bending.

### REFERENCE SIGN

10: Laminated coil

1: primary coil

2: secondary coil

3: insulating layer

4: cell

41: long side portion

42: short side portion

43: through hole

44: resin layer

45: surface-layer coil pattern

451: unconnected portion

46: back-layer coil pattern

461: unconnected portion

47: through via

48: connecting portion

481: horizontal bent portion

482: vertical bent portion

49: terminal portion

5: cell

51: connecting portion

52: short side portion

What is claimed is:

1. A laminated coil formed by stacking a plurality of coupled cells,
wherein the cells include:
a through hole formed at a center;
a resin layer made of an insulating member;
a surface-layer coil pattern formed on a front surface of the resin layer and made of a conductive member;
a back-layer coil pattern formed on a back surface of the resin layer and made of a conductive member;
a through via that electrically connects the surface-layer coil pattern and the back-layer coil pattern; and
a connecting portion that couples adjacent cells and is bent to stack the cells,
wherein a current path of current flowing through the cells has a total number of turns of 1.0 turns or more, the total number of turns being a sum of the surface-layer coil pattern and the back-layer coil pattern.

2. The laminated coil according to claim 1, wherein the current path of current flowing through the cells has a total number of turns of 1.75 turns or less, the total number of turns being a sum of the surface-layer coil pattern and the back-layer coil pattern.

3. The laminated coil according to claim 1, wherein the cells each have a rectangular shape, and the connecting portions are not provided on the same side in one cell.

4. The laminated coil according to claim 3,
wherein the cells each have a pair of short side portions and a pair of long side portions that are longer than the short side portions,
the connecting portion includes:
a horizontal bent portion bent along an extending direction of the long side portions; and
a vertical bent portion bent along an extending direction of the short side portions,
wherein, in the stacked cells, the horizontal bent portions and the vertical bent portions are alternately formed.
